(19) United States
(12) Patent Application Publication
(10) Pub. No.: US 2015/0369658 A1
(43) Pub. Date: Dec. 24, 2015

(54) LIGHT ASSEMBLY EMPLOYING UNCHARACTERIZED LIGHT SOURCES

(71) Applicants: John H. Selverian, North Reading, MA (US); David W. Hamby, Andover, MA (US)

(72) Inventors: John H. Selverian, North Reading, MA (US); David W. Hamby, Andover, MA (US)

(73) Assignee: OSRAM SYLVANIA Inc., Danvers, MA (US)

(21) Appl. No.: 14/308,390

(22) Filed: Jun. 18, 2014

(51) Int. Cl. G01J 1/42

(52) U.S. Cl. CPC G01J 1/42; G01J 2001/4252

(57) ABSTRACT

The present disclosure is directed to a light assembly employing uncharacterized light sources. An example device may comprise at least one light source, a memory and at least one interface. Light emitted by the at least one light source may be tested. Configuration data based on results of the testing may be stored in the memory. The above device may then be used in other assemblies. For example, a system may be assembled including at least one of the device and a power supply. The power supply may be able to read the configuration data from the memory and configure itself based on the configuration data. For example, to generate light with certain characteristics the power supply may use the configuration data to determine at least one drive current to cause the at least one device to emit light having the desired characteristics.

### TECHNICAL FIELD

The present invention relates to light emitting devices, and more specifically, to the assembly of devices including light sources that may have different operational characteristics.

### BACKGROUND

The evolution of lighting technology has generated a dichotomy between performance and power consumption for lighting devices. In particular, consumers desire the same or higher light emission from devices while power consumption decreases. Lighting designers have been able to fulfill these requirements by utilizing light emitting diode (LED) technology. LEDs may be able to generate relatively large amounts of light at comparatively lower power consumption. However, due to the small size of individual LEDs, it may become necessary to employ multiple LEDs in unison when creating LED-based lighting devices for existing applications. In this way, LED-based devices may mimic the performance of existing incandescent or compact fluorescent light sources at a fraction of the power consumption and often with a longer projected life span.

While the benefits of LEDs may be readily apparent, the use of a plurality of LEDs to replicate a single light source is inherently problematic in that the operational characteristics of LEDs (e.g., light color, light intensity, etc.) may vary substantially. The resulting combination of LEDs with different operational characteristics may generate light that does not have the desired uniformity, color, intensity, etc. An existing solution to solve this issue is binning. In binning, a manufacturer may test each LED to determine operational characteristics and may then sort each LED into a “bin” based on the results. While binning may generate a stock of LEDs with similar operational characteristics, it also introduces a substantial amount of waste, additional cost, etc. into the manufacturing process. In addition to the cost and effort required to perform binning, a stock of LEDs may be generated with nonconforming operational parameters. These LEDs may end up as waste unless another application to which they may be applied is found, and of course replacements are then needed to make up for these components. These negative implications of a requirement to bin LEDs become greatly magnified in high-volume production environments.

### BRIEF DESCRIPTION OF THE DRAWINGS

Reference should be made to the following detailed description which should be read in conjunction with the following figures, wherein like numerals represent like parts:

FIG. 1 illustrates an example light assembly employing uncharacterized light sources consistent with the present disclosure;

FIG. 2 illustrates an example system employing example assemblies such as disclosed in FIG. 1 consistent with the present disclosure;

FIG. 3 illustrates example operations for assembling a light assembly employing uncharacterized light sources consistent with the present disclosure; and

FIG. 4 illustrates example operations for a system of light assemblies employing uncharacterized light sources consistent with the present disclosure.

Although the following Detailed Description will proceed with reference being made to illustrative embodiments, many alternatives, modifications and variations thereof will be apparent to those skilled in the art.

### DETAILED DESCRIPTION

The present disclosure is directed to a light assembly employing uncharacterized light sources. In general, a device may comprise at least one light source that is tunable to achieve a particular character of light, and data for use in the tuning of the light source may be stored in a memory in the device. An example device may comprise at least one light source, a memory and at least one interface. Light emitted by the at least one light source may be tested to determine, for example, chromaticity data and luminous intensity data for the emitted light. Configuration data based on results of the testing may be stored in the memory. The above device may then be used in other assemblies. For example, a system may be assembled including at least one of the device and a power supply. The power supply may be able to read the configuration data from the memory and configure itself based on the configuration data. For example, to generate light with certain characteristics the power supply may use the configuration data to determine at least one drive current to cause the at least one device to emit light having the desired characteristics.

In one embodiment, a device may comprise, for example, at least one light source, a memory and at least one interface. The memory may store configuration data based on operational characteristics of the at least one light source. The at least one interface may be coupled to the at least one light source and the memory.

The at least one interface may couple the device to test equipment to test the operational characteristics of the at least one light source. In one embodiment, the at least one light source may comprise at least one light emitting diode. For example, the at least one light source may comprise a plurality of light emitting diodes, each of the plurality of light emitting diode being configured to emit a certain color of light. The at least one interface may further allow the test equipment to test operational characteristics of the plurality of light emitting diodes, the plurality of light emitting diodes being tested in groups based on light color emission. The configuration data may be based on chromaticity and luminous intensity measured for the certain color of light emitted from each of the groups of light emitting diodes during the testing.

In the same or another embodiment, the at least one interface may further couple the device to a power supply in a system, provide the configuration data from the memory to the power supply, receive at least one driving current from the power supply and provide the at least one driving current to the at least one light source. In one embodiment, an example method for assembling a device consistent with the present disclosure may comprise assembling a device including at least one light source and a memory, testing the operational characteristics of the at least one light source and storing configuration data in the memory based on the testing. In the same or another embodiment, an example method for operating a system may comprise reading configuration data from at least one device in a system also including a power supply, the configuration data pertaining to operational characteristics of at least one light source in the device, and configuring the power supply based at least on the configuration data.

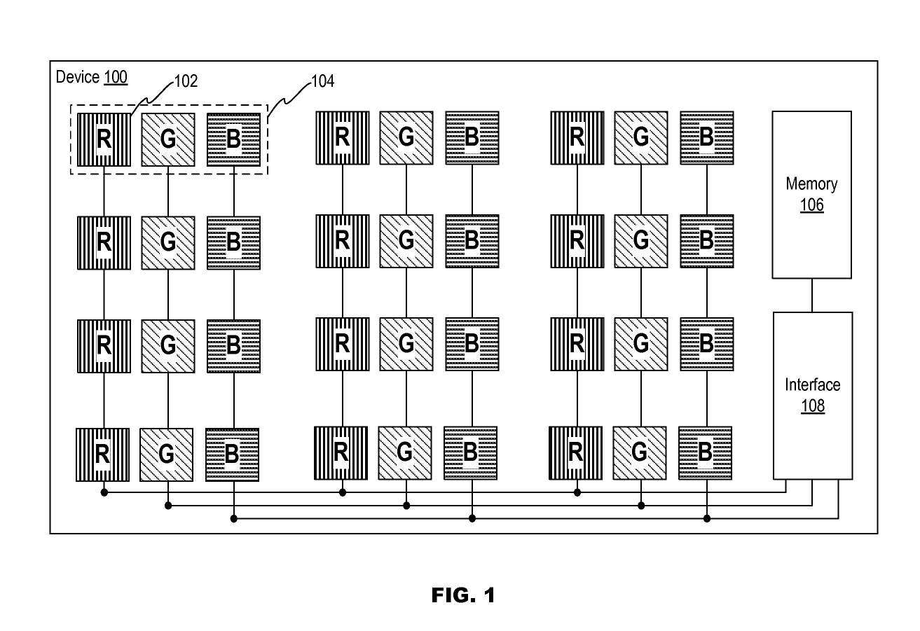

FIG. 1 illustrates an example light assembly employing uncharacterized light sources consistent with the present disclosure. Initially, it is important to note that device and/or system assemblies presented in this disclosure are merely examples provided for the sake of explanation. Any deviation in regard to element placement, orientation, composition, number, shape, size, etc. may still be consistent with the teachings of the present disclosure. Moreover, the devices and/or systems represented in this disclosure may comprise components that may vary in relative scale (e.g., size with respect to each other), as the relative scale of these components may be dependent on a variety of factors including, for example, the component material makeup, the requirements of the application for which the device is being manufactured, the manufacturing process, etc.

Device 100 in FIG. 1 may comprise at least one light source 102, memory 106 and at least one interface 108. In one example implementation, device 100 may comprise a plurality of light sources 102 configured to generate light of different colors. For example, the plurality of light sources 102 may be LEDs such as, but not limited to, indium gallium aluminum phosphide (InGaAIP) LEDs configured to emit red (“R” in FIG. 1) light, indium gallium nitride (InGaN) LEDs configured to emit blue (“B” in FIG. 1) light and green-converted InGaN LEDs configured to emit green (“G” in FIG. 1) light. The combined emission of R, G and B light sources 102, as shown at 104, may yield what the human eye considers to be white light, the characteristics of which may be controlled by the amount of R, G and B contribution. For example, the color temperature in Kelvin of 3000K may be considered a “colder” light including more B and/or G contribution, while a 2700K light may be considered “warmer” with a greater R contribution.

Consistent with the present disclosure, R, G and B light sources 102 may be arranged in a manner to generate light with certain characteristics (e.g., color temperature, intensity, etc.). While an example arrangement is illustrated, other arrangements are possible. Variations may include light sources 102 being configured to emit less or more than three colors, being arranged in a different pattern, including a greater concentration of one color as compared to another, etc. In one embodiment, a target light output may be defined by the intended use for which a lighting fixture was designed. An example target light output may have a correlated color temperature (CCT) of 3000K and luminous intensity of 1000 lm based on a black body reference. A CCT of 3000K may correspond to, for example, a Cx of 0.437 and a Cy of 0.404 using the International Commission on Illumination (CIE) 1931 XYZ color space. R, G and B color channels may then be set for light sources 102 in device 100 wherein red (R) may be defined as having a Cx=0.681, Cy=0.318, green (G) may be defined as having a Cx=0.427, Cy=0.498 and blue (B) may be defined as having a Cx=0.240, Cy=0.280. In an example of operation, during calibration the Cx, Cy and lumen of each of the three color channels may be measured using a photometric integrating sphere at various drive currents. Polynomial curves (e.g., plotting light output against drive current) for each of the color channels may then be fit to the measurement data for use in calibrating device 100. Knowing the Cx and Cy of the three channels, along with the Cx and Cy of the target light output, the lumens of each color required to hit the target light output may be calculated using photometric equations. The polynomial curves may then be used to determine the required drive currents for the three channels to generate the target light output. Some or all of these operations may be iterated to make fine adjustments if the Cx and Cy of the three color channels vary significantly with the drive current. However, in practice iteration may prove to be unnecessary since, once the approximate drive currents are determined, the calibration can be done in this current region without noticeable light output color shift.

R, G and B light sources 102 may be coupled to at least one interface 108. Given an embodiment wherein light sources 102 are LEDs configured to emit R, G and B light, the LEDs may be coupled in series so LEDs configured to emit the same color of light may operate as one or more groups (e.g., all same-colored LEDs may be a group, all same-colored LEDs in a column may be a group, etc.). All light sources 102 in the same group may be driven in the same manner to generate a certain light output. Memory 106 may comprise programmable read-only memory (PROM), erasable programmable read-only memory (EPROM), Flash memory, memory within a wireless transponder utilizing (IR) technology, radio frequency (RF) technology (e.g., based on the RF Identification (RFID) standard, the Near Field Communication (NFC) standard, etc.), or another similar electronic memory. Alternatively, memory 106 may comprise printed media on which the configuration data may be written. Printed media may comprise, for example, legible characters and/or machine-readable indicia such as bar codes, QR codes, etc. Whether memory 106 needs to be able to write data only once or being rewritable may be application dependent.

Interface 108 may comprise physical (e.g., wired) and/or wireless resources to couple light sources 102 and/or memory 106 to equipment external to device 100. Wired interfaces 108 may include, for example, sockets, plugs, connectors, etc. and any other electronic componentry that may be needed to support interaction between device 100 and external equipment. Wireless interfaces 108 may include at least wireless transceivers to support close-proximity, short-range or long-range wireless communication. For example, interface 108 may couple at least one light source 102 to external test equipment for testing. The same or another interface 108 may couple memory 106 to the external test equipment to at least receive configuration data resulting from testing of at least one light source 102. In an example of operation, device 100 may be coupled to test equipment 100 for testing at least one light source 102. Testing may occur as part of the assembly process for device 100, post-manufacture (e.g., device 100 may be assembled, put into storage and then tested later), etc. The test equipment may cause at least one light source 102 in device 100 to emit light, and then may measure the characteristics of the emitted light using, for example, a photometric sphere or other measurement device. Example characteristics that may be measured may include chromaticity of the emitted light, luminous intensity of the light, etc. In one embodiment, groups of light sources 102 may be measured so that, for example, all R LEDs are measured at once, then all B LEDs are measured, then all G LEDs are measured, etc.

After testing has been completed, the test equipment may write configuration data to memory 106 (e.g., via interface 108). In general, the configuration data may be based on the operational characteristics (e.g., the chromaticity, luminous intensity, etc. of the emitted light). However, different embodiments of configuration data are possible. For example, configuration data may simply contain results of the testing such as x, y chromaticity coordinates along with a luminous intensity measurement in lumens corresponding to each light source 102, each group of light sources 102, etc. This data may be usable to determine how drive light source 102 or group of light sources 102 to achieve a desired light output. Along with, or instead of, the simple test results, the configuration data stored on memory 106 may comprise an actual “recipe” for light output having particular characteristics. For example, the configuration data may comprise drive currents for driving groups of R, G and B light sources 102 to achieve light emission having a particular color, intensity, etc. In one embodiment, configuration data may also include other data such as, but not limited to, serial number data, manufacturing lot data, time-in-use data, etc.

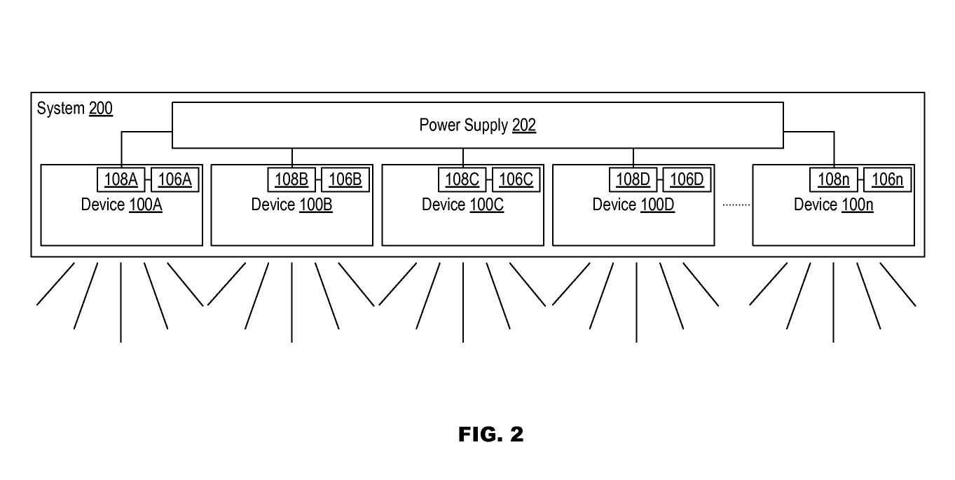

At least one benefit that may be realized in embodiments consistent with the present disclosure is the near 100% acceptance and use of all light sources 102 (e.g., taking into account that it is normal during assembly for some light sources 102 to be deemed be defective in that no light is emitted). When applied to existing systems wherein a large volume of light sources 102 including LED raw die, packaged components, etc. are being placed, high material use efficiency may result in substantial savings in energy, time, cost, etc. In existing systems light sources 102 may be rejected based on their operational characteristics, and thus, must be repurposed, resold, discarded, etc. The configurability of the various embodiments disclosed herein not only allows for light sources 102 with differing operational characteristics to be used, but to be used together in device 100, and as will be disclosed in FIG. 2, in systems employing at least one device 100.

FIG. 2 illustrates an example system employing example assemblies such as disclosed in FIG. 1 consistent with the present disclosure. Device 100 may be modular in that one or more of device 100 may be employed together for a particular application. System 200 may comprise, for example, device 100A, device 100B, device 100C, device 100D . . . device 100n (collectively, “devices 100A-n”). At least one power supply 202 may be coupled to each of devices 100A-n in a manner that allows power supply 202 to both communicate with and provide power to devices 100A-n. The coupling may be made through interface 108A, interface 108B, interface 108C, interface 108D . . . interface 108n (collectively, “interfaces 108A-n) in each of devices 100A-n, respectively. Moreover, each device 100A-n may comprise memory 106A, memory 106B, memory 106C, memory 106D . . . memory 106n (collectively, “memories 106A-n”), respectively.

In an example of operation, power supply 202 may communicate with each memory 106A-n (e.g., via interfaces 108A-n) to obtain configuration data for each device 100A-n. Power supply 202 may then use the configuration data to configure itself. For example, it may receive the configuration data for each device 100A-n, and may determine a driving current, or set of driving currents, based on the configuration data for driving each device 100A-n to produce light having certain characteristics. While not illustrated in FIG. 2, power supply 202 may comprise, for example, communication circuitry, control circuitry, voltage/current conversion circuitry, feedback circuitry, protection circuitry, sensors and/or other componentry that may be required for controlling devices 100A-n. The determination of driving currents may take into account the configuration data for each group of light sources 102 in each device 100A-n. The data may comprise, for example, raw measurements that may be processed within power supply 202 to formulate required drive currents, a recipe comprising the required drive currents, etc. In one embodiment, the certain characteristics of the light to be produced by system 200 may be preset in power supply 202. In an alternative embodiment, power supply 202 may be configurable by an installer, a user, etc. For example, power supply 202 may comprise a user interface, a wired or wireless interface to allow another device with a user interface to be coupled, etc. to allow a desired light output to be configured in system 200. Power supply 202 may use the configured light settings, along with the configuration data from memories 106A-n, to then determine a configuration for powering (e.g., providing at least a driving current to) devices 100 A-n. In this manner system 200 may be customized based on the particular application to which it is applied.

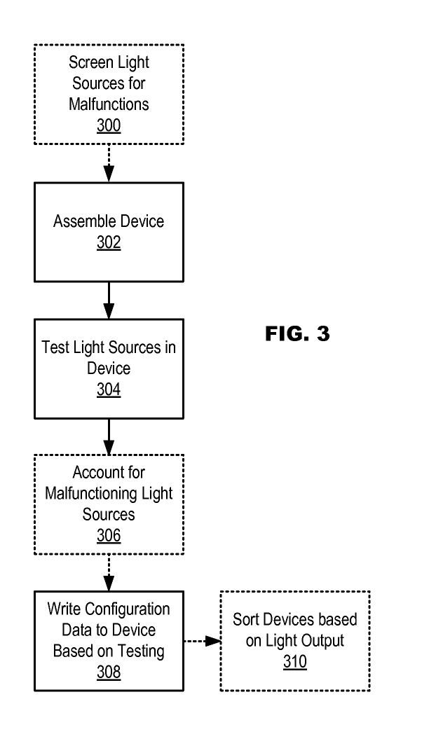

FIG. 3 illustrates example operations for assembling a light assembly employing uncharacterized light sources consistent with the present disclosure. In general, operations 300 to 310 describe a manufacturing process by which a device 100 may be assembled. Operations 300 and 306 may be optional in that these operations deal with handling light sources 102 that may malfunction, be defective, etc. Malfunctioning and/or defective light sources 102 may be addressed before device assembly commences (e.g., in operation 300 wherein light sources 102 may be screened prior to assembly) or after device 100 has been assembled in operation 302.

Assembled device 100 may then be tested in operation 304. For example, device 100 may be coupled to test equipment (e.g., via interface 108). The test equipment may then cause light sources 102, or groups of light sources 102, to illuminate. Operational characteristics for light sources 102 (e.g., chromaticity, luminous intensity, etc.) may then be recorded. Optionally, in operation 306 any malfunctioning/defective light source 102 may be addressed. For example, malfunctioning or defective light sources may be removed/reapplied, replaced or may simply be removed from operation. In an example device 100 wherein light sources 102 are connected in series, removing a light source 102 from operation may comprise shorting out the malfunctioning or defective light source 102 through application of a conductive material (e.g., conductive ink, solder, etc.). Configuration data based on the results of the testing that occurred in operation 304 may then be written to memory 106 in operation 308. Writing the configuration data to memory 106 in operation 308 may include storing the configuration data electronically, in printed format, etc. Optionally, if the assembly process is configured to yield devices 100 having a preset light output (e.g., based on the configuration data in memory 106 comprising a recipe to generate light having certain characteristics), then device 100 may be sorted based on the preset light output.

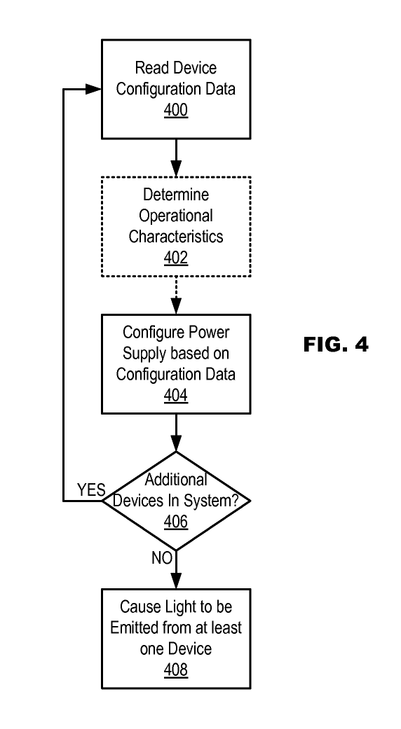

FIG. 4 illustrates example operations for a system of light assemblies employing uncharacterized light sources consistent with the present disclosure. Initially, power supply 202 in system 200 may read configuration data from a device 100 in operation 400. Operation 402 may be optional in that it may depend on the implementation of system 200. Operation 402 may not be necessary if, for example, system 200 generates light having fixed characteristics. On the other hand, if system 200 is configurable (e.g., when installed, by an end user, etc.) to generate light having variable characteristics, then in operation 402 operational characteristics for system 200 (e.g., the quality of light to generate) may be determined. In operation 404, power supply 202 may be configured based at least one on the configuration data, and possibly on the desired operational characteristics determined in operation 402. Configuring power supply 202 may comprise, for example, setting at least one drive current to drive at least one light source 102 in device 100. In operation 406 a determination may be made as to whether additional devices 100 exist in system 200. Operations 400 to 406 may continue until power supply 202 is configured for all devices in system 200. In operation 408 power supply 202 may cause light to be emitted from at least one device 100 in system 200 using the configuration setup in operations 400-406.

While FIGS. 3 and 4 illustrate various operations according to different embodiments, it is to be understood that not all of the operations depicted in FIGS. 3 and 4 are necessary for other embodiments. Indeed, it is fully contemplated herein that in other embodiments of the present disclosure, the operations depicted in FIGS. 3 and 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to a light assembly employing uncharacterized light sources. An example device may comprise at least one light source, a memory and at least one interface. Light emitted by the at least one light source may be tested. Configuration data based on results of the testing may be stored in the memory. The above device may then be used in other assemblies. For example, a system may be assembled including at least one of the device and a power supply. The power supply may be able to read the configuration data from the memory and configure itself based on the configuration data. For example, to generate light with certain characteristics the power supply may use the configuration data to determine at least one drive current to cause the at least one device to emit light having the desired characteristics.

The following examples pertain to further embodiments. According to one aspect there is provided a device. The device may comprise at least one light source, a memory to store configuration data based on operational characteristics of the at least one light source; and at least one interface coupled to the at least one light source and the memory.

According to another aspect there is provided a method. The method may comprise assembling a device including at least one light source and a memory, testing the operational characteristics of the at least one light source and storing configuration data in the memory based on the testing.

According to another aspect there is provided a method. The method may comprise reading configuration data from at least one device in a system also including a power supply, the configuration data pertaining to operational characteristics of at least one light source in the device, and configuring the power supply based at least on the configuration data.

According to another aspect there is provided at least one machine-readable storage medium. The medium may have stored thereon, individually or in combination, instructions that when executed by one or more processors result in the following operations for assembling a device, comprising assembling a device including at least one light source and a memory, testing the operational characteristics of the at least one light source and storing configuration data in the memory based on the testing.

According to another aspect there is provided at least one machine-readable storage medium. The medium may have stored thereon, individually or in combination, instructions that when executed by one or more processors result in the following operations for operating a system, comprising reading configuration data from at least one device in a system also including a power supply, the configuration data pertaining to operational characteristics of at least one light source in the device and configuring the power supply based at least on the configuration data.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A device, comprising:
at least one light source;
a memory to store configuration data based on operational characteristics of the at least one light source; and
at least one interface coupled to the at least one light source and the memory.

2. The device according to claim 1, wherein the at least one interface is to couple the device to test equipment to test the operational characteristics of the at least one light source.

3. The device according to claim 2, wherein the at least one light source comprises at least one light emitting diode.

4. The device according to claim 2, wherein the at least one light source comprises a plurality of light emitting diodes, each of the plurality of light emitting diode being configured to emit a certain color of light.

5. The device according to claim 4, wherein the at least one interface further allows the test equipment to test operational characteristics of the plurality of light emitting diodes, the plurality of light emitting diodes being tested in groups based on light color emission.

6. The device according to claim 5, wherein the configuration data is based on chromaticity and luminous intensity measured for the certain color of light emitted from each of the groups of light emitting diodes during the testing.

7. The device according to claim 1, wherein the at least one interface further:
couples the device to a power supply in a system;
provides the configuration data from the memory to the power supply;
receives at least one driving current from the power supply; and
provides the at least one driving current to the at least one light source.

8. A method for assembling a device, comprising:
assembling a device including at least one light source and a memory;
testing the operational characteristics of the at least one light source; and
storing configuration data in the memory based on the testing.

9. The method according to claim 8, wherein the testing comprises:
causing the at least one light source to emit light;
measuring at least chromaticity and luminous intensity of the emitted light; and
determining the configuration data based on the measured chromaticity and luminous intensity.

10. The method according to claim 8, wherein the testing comprises:
determining if the at least one light source doesn't emit light; and
if it is determined that the at least one light source does not emit light, at least one of replacing the at least one light source or shorting out the at least one light source.

11. The method according to claim 8, further comprising:
assembling a system comprising at least one of the device and a power supply;
reading the configuration data from the memory in the at least one device; and
configuring the power supply based at least on the configuration data.

12. A method for operating a system, comprising:
reading configuration data from at least one device in a system also including a power supply, the configuration data pertaining to operational characteristics of at least one light source in the device; and
configuring the power supply based at least on the configuration data.

13. The method according to claim 12, further comprising:
determining preferred operational characteristics for the system; and
configuring the power supply also based on the preferred operational characteristics.

14. The method according to claim 12, wherein configuring the power supply comprises setting the power supply to provide at least one drive current to cause the at least one light source to emit light.

15. At least one machine-readable storage medium having stored thereon, individually or in combination, instructions that when executed by one or more processors result in the following operations for assembling a device, comprising:
assembling a device including at least one light source and a memory;
testing the operational characteristics of the at least one light source; and
storing configuration data in the memory based on the testing.

16. The medium according to claim 15, wherein the instructions for testing comprise instructions that when executed by one or more processors result in the following operations, comprising:
causing the at least one light source to emit light;
measuring at least chromaticity and luminous intensity of the emitted light; and
determining the configuration data based on the measured chromaticity and luminous intensity.

17. The medium according to claim 15, wherein the instructions for testing comprise instructions that when executed by one or more processors result in the following operations, comprising:
determining if the at least one light source doesn't emit light; and
if it is determined that the at least one light source does not emit light, at least one of replacing the at least one light source or shorting out the at least one light source.

18. The medium according to claim 15, further comprising instructions that when executed by one or more processors result in the following operations, comprising:
assembling a system comprising at least one of the device and a power supply;
reading the configuration data from the memory in the at least one device; and
configuring the power supply based at least on the configuration data.

19. At least one machine-readable storage medium having stored thereon, individually or in combination, instructions that when executed by one or more processors result in the following operations for operating a system, comprising:
reading configuration data from at least one device in a system also including a power supply, the configuration data pertaining to operational characteristics of at least one light source in the device; and
configuring the power supply based at least on the configuration data.

20. The medium according to claim 19, further comprising instructions that when executed by one or more processors result in the following operations, comprising:
determining preferred operational characteristics for the system; and
configuring the power supply also based on the preferred operational characteristics.

21. The medium according to claim 19, wherein the instructions for configuring the power supply comprise instructions that when executed by one or more processors result in the following operations, comprising:
setting the power supply to provide at least one drive current to cause the at least one light source to emit light.
